(19) United States
(12) Patent Application Publication
(10) Pub. No.: US 2019/0390499 A1
(43) Pub. Date: Dec. 26, 2019

(54) Smooth-Stop

(71) Applicants: David Alexander Liddle, (US); Justin Allen Liddle, (US)

(72) Inventor: Jeffrey Brian Liddle, Mt Juliet, TN (US)

(21) Appl. No.: 16/016,578

(22) Filed: Jun. 23, 2018

(51) Int. Cl. E05F 5/00

(52) U.S. Cl. CPC E05F 5/00; E05F 7/005

(57) ABSTRACT

The invention is an apparatus intended to replace the wooden blocks to which the Euro Door Stops by FastCap are usually fastened; the use of this invention will be most relevant to the custom cabinetry industry. The invention will be used to provide consistency and accuracy in the placement of the Euro Door Stop cabinet hardware and replace the wooden blocks which are currently used.

### 1 CROSS-REFERENCE TO RELATED APPLICATIONS

Not Applicable

### 2 STATEMENT REGARDING FEDERALLY SPONSORED RESEARCH OR DEVELOPMENT

Not Applicable

### 3 REFERENCE TO SEQUENCE LISTING, A TABLE, OR A COMPUTER PROGRAM LISTING COMPACT DISC APPENDIX

Not Applicable

### 4 BACKGROUND OF THE INVENTION

The invention is applicable to the field of custom cabinetry. Without the use of this invention, cabinet makers must install a wooden block on which to secure the Euro Door Stops by FastCap; these wood blocks are prone to splitting with routine opening and closing of cabinet doors and must be replaced frequently. The invention replaces the wood blocks on which the Euro Door Stops are fastened and lasts the lifetime of the cabinet.

### 5 BRIEF SUMMARY OF THE INVENTION

The invention is designed to sit inside the cabinet, placed against and secured to the faceplate, and to the inner surface of the cabinet. The invention contains a perforated space in the center, which can be used to either accurately line the invention up with the center of the cabinet, or to easily cut the invention in half when only one Euro Door Stop is needed. The invention contains a total of six fastening positions, three on either side of the perforated space, for securing the invention to the cabinet. Two recessed screw guides are located on the top surface of the invention and serve as the location at which the Euro Door Stops are to be fastened. The invention comes in four heights to work with the different standard faceplate overlaps.

### 6 BRIEF DESCRIPTION OF THE SEVERAL VIEWS OF THE DRAWING

FIG. 1

Depicts the invention, with the fastener positions (detail (a)), the perforated space (detail (b)), and the recessed screw guide for the Euro Door Stop (detail (c)).

FIG. 2

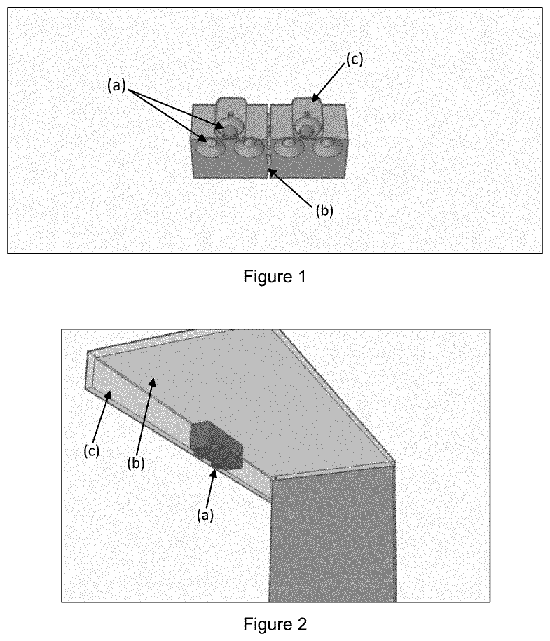

Depicts an example placement of the invention (detail (a)), where details (b) and (c) are the inner surface of the cabinet and the face plate, respectively.

### 7 DETAILED DESCRIPTION OF THE INVENTION

The invention is designed to sit inside the cabinet, placed against and secured to the faceplate, and to the inner surface of the cabinet. The invention contains a perforated space in the center, which can be used to accurately line the invention up with the center of the cabinet. On each side of the perforated space, the invention contains three fastening positions, one on the top surface and two on the inner surface parallel to the cabinet face plate. The fastening position on the top surface secures the invention to the inner surface of the cabinet. The two fastening positions on the inner surface secure the invention to the faceplate of the cabinet. Two recessed screw guides are located on the top surface of the invention, one on either side of the perforated space, and serve as the locations at which the Euro Door Stops are to be fastened. In situations where only one Euro Door stop is needed, i.e., a cabinet with just one door, the invention can be cut in half along its perforated space. The invention comes in four heights to work with the different standard faceplate overlaps: 0.814-inches, 0.564-inches, 0.438-inches, and 0.313-inches.

1. The invention contains a perforated space in its middle to serve either as a guide for accurately lining it up with the center of the cabinet, or for easily cutting it into two pieces.

2. The invention contains two recessed screw guides on the top surface, one on either side of the perforated space, to serve as the locations at which the Euro Door Stops by FastCap are to be fastened.

3. The invention contains six fastening locations, two on the top surface and four on the inner surface, parallel to the face plate. The two positions on the top surface are for securing the invention to the inner surface of the cabinet. The four positions on the inner surface are for securing the invention to the face plate of the cabinet.
